(19) United States
(12) Patent Application Publication
(10) Pub. No.: US 2010/0323335 A1
(43) Pub. Date: Dec. 23, 2010

(54) PSYCHOTHERAPEUTIC DEVICE

(76) Inventor: In Tae Lee, Hwaseong-si (KR)

Correspondence Address: CHRISTOPHER PAUL MITCHELL, 888 16TH ST., NW, SUITE 800, WASHINGTON, DC, 20006, US

(21) Appl. No.: 12/528,623

(22) PCT Filed: Jan. 21, 2009
(86) PCT No.: PCT/KR09/00305

§ 371 Date: Aug. 25, 2009

(30) Foreign Application Priority Data
May 19, 2008 (KR) 10-2008-0046046
Sep. 29, 2008 (KR) 10-2008-0095406
Jan. 20, 2009 (KR) 10-2009-0004813

(51) Int. Cl. G09B 19/00

(52) U.S. Cl. 434/236

(57) ABSTRACT

Disclosed herein is a psychotherapeutic device which induces saccadic eye movement of a user in a certain way, thus increasing the efficacy of psychiatric treatment for the user. The psychotherapeutic device in accordance with the present invention includes a main body including a frame having an opened portion corresponding to a user's eyes, a support means for placing the frame on the user's face, and a front panel connected to a front surface of the frame and providing light spots moved left and right with respect to the user's eyes; and a control box for controlling the operation of the front panel, wherein the main body and the control box are electrically connected to each other by a wire.

### TECHNICAL FIELD

The present invention relates to a psychotherapeutic device which induces saccadic eye movement of a user in a certain way, thus providing the efficacy of psychiatric treatment for the user.

### BACKGROUND ART

Various kinds of accidents such as wars, natural disasters, etc. as well as traffic accidents, rapes, violence, etc. have occurred in human society. Such accidents have a serious effect on a person's mental health, and the persons who have experienced such accidents suffer from psychiatric disorders such as painful memories, post-traumatic stress disorder, and further phobias, panic attacks, childhood emotional disorders, etc.

Conventionally, psychotherapeutic methods depending on drugs have been mainly used. However, since these treatment methods require long treatment times and the treatment effects are limited, a large number of persons still suffer from the above psychiatric disorders.

It is reported that methods of stimulating both brains by moving both eyes left and right, slapping both knees alternately, or providing sound to both ears alternately are efficacious as the psychotherapeutic methods.

Especially, in 1987, American psychologist Francine Shapiro discovered one day that saccadic eye movement reduces negative and unpleasant feelings and is very efficacious in treating phobias, panic disorders, etc. This eye movement is called Eye Movement Desensitization and Processing (EMDR). EMDR is performed in such a simple way that a doctor moves his or her finger left and right and makes a patient gaze at the finger with both eyes such that the patient moves his or her eyes left and right at a constant speed and, at the same time, the doctor stimulates the palms of the patient's hands, for example. EMDR has been applied in many other psychiatric treatments, and it is reported that EMDR provides satisfactory results to both doctors and patients since its efficacy is high and the treatment time is reduced compared to the conventional drug treatment methods.

Moreover, it is reported that the method of stimulating both brains is efficacious in treating simple anxiety disorders or phobias caused by some unpleasant memories of the past as well as severe psychiatric diseases.

Generally, in order to receive the psychiatric treatment, the patient should go to a psychiatric hospital and see a psychiatrist. However, a person who is experiencing simple emotional anxiety, not a serious case, has psychological and time limitations to see the psychiatrist. Thus, a large number of persons are living with psychiatric disorders which can be treated by a simple brain stimulation exercise.

### DISCLOSURE

### [Technical Problem]

The present invention has been made in an effort to solve the above-described problems. Accordingly, the present invention provides a psychotherapeutic device which allows a user to conduct a psychiatric treatment by his or herself in a simple method of stimulating both brains.

### [Technical Solution]

In one aspect, the present invention provides a psychotherapeutic device including: a main body including a frame having an opened portion corresponding to a user's eyes, a support means for placing the frame on the user's face, and a front panel connected to a front surface of the frame and providing light spots moved left and right with respect to the user's eyes; and a control box for controlling the operation of the front panel, wherein the main body and the control box are electrically connected to each other by a wire.

The front panel may be connected to the frame to be moved up and down.

The front panel may be rotatably connected to a middle portion of the frame.

The main body may further include a vibrating means provided at positions corresponding to both sides of the user's face.

The main body may further include an earphone for outputting a voice signal therethrough.

The front panel may include a plurality of LEDs provided in the inside thereof in the longitudinal direction to provide the light spots, in which the plurality of LEDs are divided into a first row corresponding to the left eye of the user and a second row corresponding to the right eye of the user, the plurality of LEDs in the first row and the second row are turned on and off one by one, and the turned-on position is sequentially moved in the left or right direction.

The control box may further include a position adjustment means for adjusting the positions of the LEDs which are simultaneously turned on and off among the LEDs in the first and second rows.

The control box may output a meditation music through the earphone.

The control box may further include a light amount adjustment means for adjusting the amount of light emitted from the LEDs.

The front panel may be a display.

The psychotherapeutic device may further include a vibration generating means for applying a physical stimulus to the left and right sides of the user's body, wherein the control box operates the vibration generating means in synchronization with the operation of the front panel.

The front panel may include a shielding pate provided on the front surface thereof, the shielding plate being connected to the frame to be moved up and down.

### ADVANTAGEOUS EFFECTS

According to the present invention having the above configuration, the user can perform the eye movement accurately and conveniently only by gazing at the light displayed on the front panel while the main body according to the present invention is placed on the user's face.

Moreover, since the vibration generating means is driven in synchronization with the operation of the front panel, the user can receive the psychiatric treatment according to the brain stimulation method without the aid of a doctor.

### DESCRIPTION OF DRAWINGS

FIG. 1 is a perspective view of a psychotherapeutic device in accordance with a preferred embodiment of the present invention;

FIG. 2 is a front perspective view of a main body 1 of FIG. 1;

FIG. 3 is a rear perspective view of the main body 1 of FIG. 1;

FIG. 4 is an exploded perspective view of FIG. 2;

FIG. 5 is an exploded perspective view of FIG. 3;

FIG. 6 is a block diagram schematically showing the configuration of a driving circuit of the main body 1;

FIG. 7 is a front perspective view of a control box 2 of FIG. 1;

FIG. 8 is a rear perspective view of the control box 2 of FIG. 1;

FIG. 9 is a block diagram schematically showing an internal circuit of the control box 2;

FIG. 10 is a perspective view of a vibrating pad 5;

FIG. 11 is a diagram illustrating an arrangement of LEDs formed in a front panel 13 of FIG. 1;

FIG. 12 is a diagram illustrating the operation of the psychotherapeutic device in accordance with the preferred embodiment of the present invention; and

FIGS. 13 to 15 are diagrams illustrating a focus adjustment operation with respect to light spots seen through a user's eyes.

### NODE FOR INVENTION

Hereinafter, preferred embodiments in accordance with the present invention will be described with reference to the accompanying drawings. The preferred embodiments are provided so that those skilled in the art can sufficiently understand the present invention, but can be modified in various forms and the scope of the present invention is not limited to the preferred embodiments.

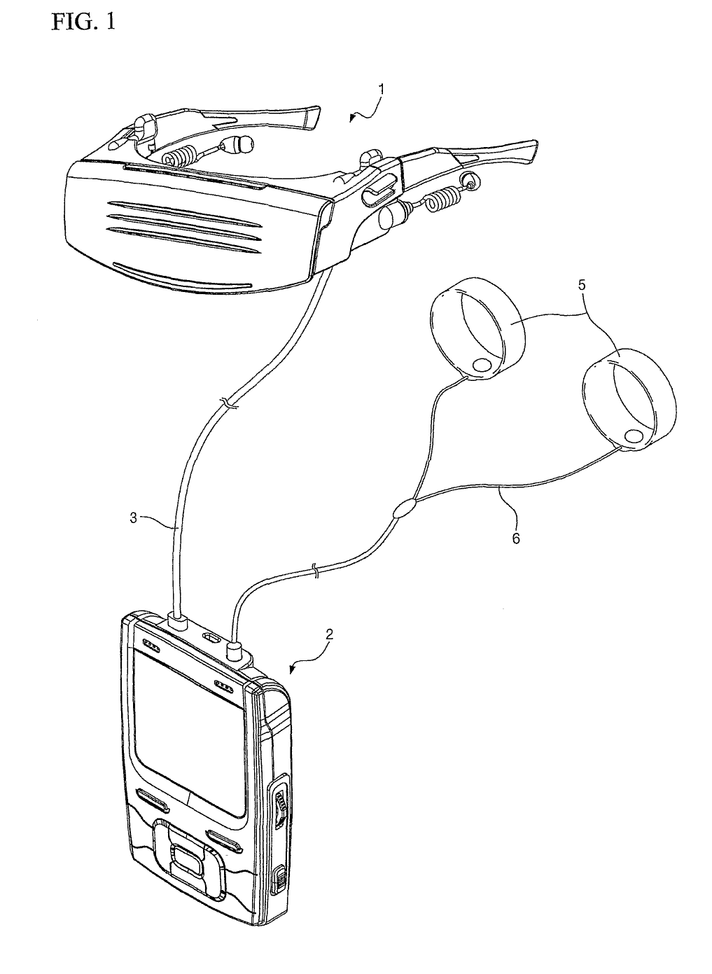

FIG. 1 is a perspective view of a psychotherapeutic device in accordance with a preferred embodiment of the present invention.

In FIG. 1, the psychotherapeutic device basically comprises a main body 1 placed on a user's face and a control box 2. Moreover, a vibrating pad 5 which can be worn on the user's wrist is selectively included.

The main body 1 and the vibrating pad 5 are electrically connected to the control box 2 via wires 3 and 6, and the wires 3 and 6 are detachably connected to the control box 2.

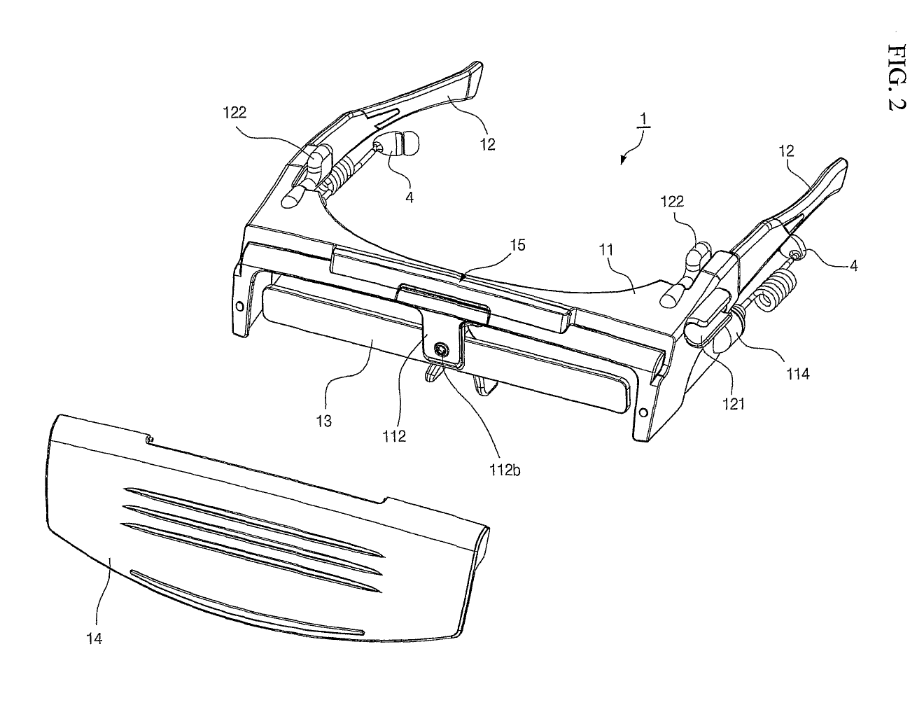

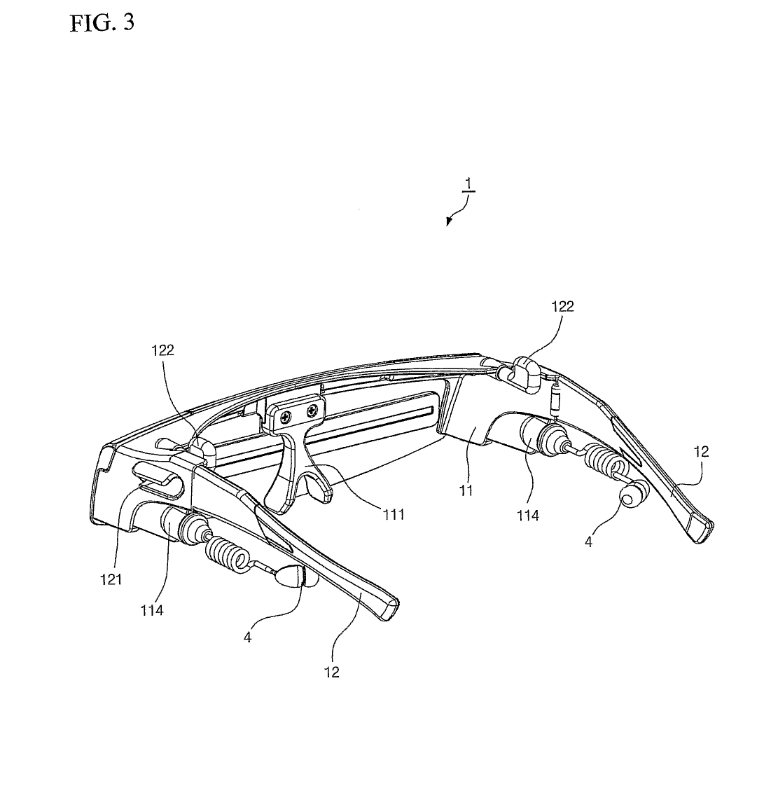

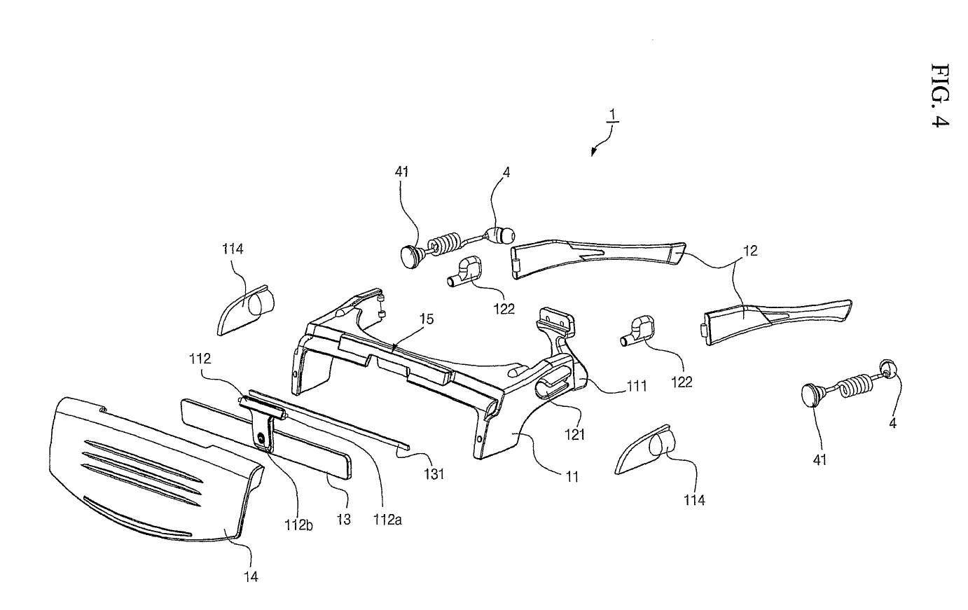

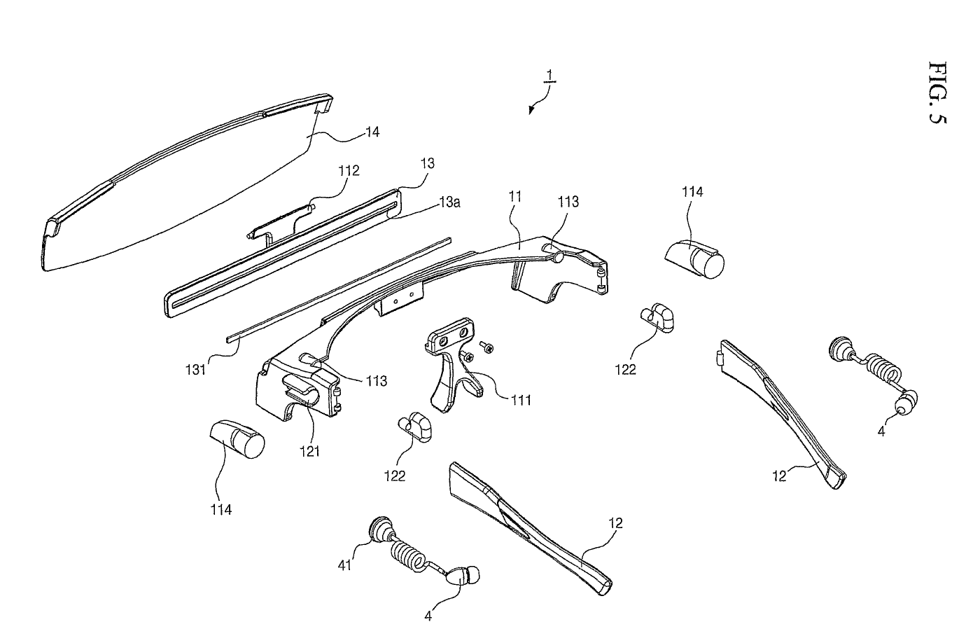

FIGS. 2 and 3 are front and rear perspective views of the main body 1, and FIGS. 4 and 5 are exploded perspective views of FIGS. 2 and 3.

The main body 1 includes a frame 11 having an opened front side and a pair of legs 12 connected to both sides of the frame 11 and used to place the main body 1 on the user's temple areas or ears. Each of the legs 12 is foldably connected to the frame 11 by a hinge. A support 111 supporting the main body 1 on the user's nose is connected to a middle portion of the rear of the frame 11. The legs 12 and the support 111 are provided as support means supporting the main body 1 on the user's face. Moreover, the support means is not limited to the above structure, and the frame 11 may be fixed on the user's head using a band, for example.

Moreover, a connecting member 112 for connecting a front panel 13 to the frame 11 is mounted on a middle portion of the front of the frame 11. Especially, the connecting member 112 is hinge-connected to the frame 11, and the front panel 13 is connected to the connecting member 112 by a pivot 112b. Accordingly, the front panel 13 is connected to the frame 11 to be moved up and down with respect to a hinge axis 112a and rotated with respect to the pivot 112b.

The front panel 13 is formed of a transparent material such as glass or synthetic resin, and an LED substrate receiving groove 13a is provided in the middle of the inside of the front panel 13 in the longitudinal direction to receive an LED substrate 131. A plurality of LEDs are mounted on the LED substrate 131 in the longitudinal direction. Moreover, the front panel 13 may be a display such as an LCD. Furthermore, a shielding plate 14 formed of an opaque material is provided on the front surface of the front panel 13. The shielding plate 14 is hinge-connected to the frame 11 to be moved up and down.

A receiving portion 15 for receiving a substrate is provided in the middle portion of the front of the frame 11. A circuit for driving the main body 1 is mounted on the substrate in the receiving portion 15. Although not shown in the figures, the substrate received in the receiving portion 15 is electrically connected to the LED substrate 131 through a flexible cable and also electrically connected to a vibrating unit 122 to be described later. Moreover, although not shown in the figures, the connecting member 112 has a through-hole for connecting the front panel 13 and the receiving portion 15, and each of the front panel 13 and the receiving portion 15 has a through-hole corresponding thereto. The flexible cable is placed in the through-holes.

Meanwhile, an earphone support 121 for supporting an earphone 4 is provided on both sides of the frame 11, and a vibrating unit connecting groove 113 for connecting the vibrating unit 122 is provided on both sides of the rear of the frame 11. An earphone jack holder 114 for holding an earphone jack 41 of the earphone 4 is provided on both sides of the bottom of the frame 11. Although not shown in the figure, a wire port for introducing the wire 3 is provided on one side of the bottom of the frame 11. This wire port is led into the frame 11 and electrically connected to a driving circuit and the earphone jack holder 114.

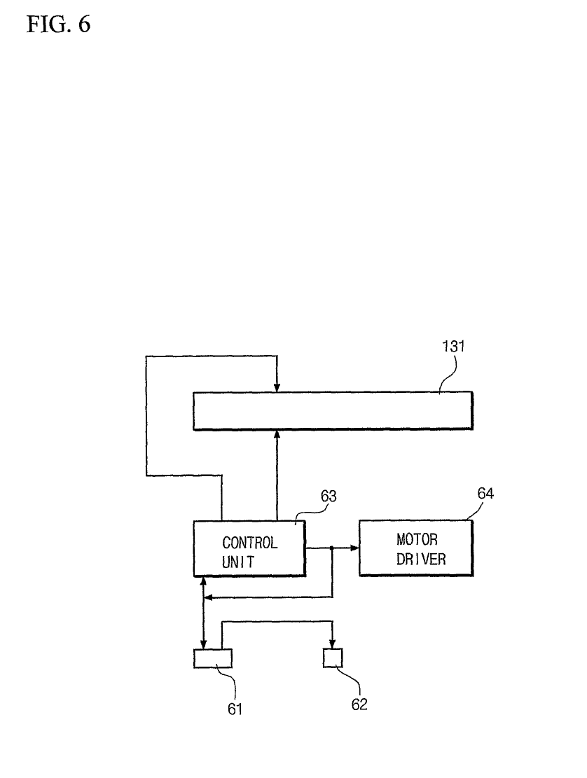

FIG. 6 is a block diagram schematically showing the configuration of the driving circuit provided in the main body 1. The driving circuit includes a wire port 61 to which the wire 3 connected to the control box 2 is connected, an earphone connecting port 62 connected to the earphone 4, and a control unit 63 for controlling the LED substrate 131 and a motor driver 64 based on control data transmitted from the control box 2 through the wire port 61, and the motor driver 64 for controlling a vibrating motor of the vibrating unit 122 under the control of the control unit 63.

The operating power of the main body 1 is supplied from the control box 2 through the wire 3. Moreover, the control box 2 provides control data for driving the LEDs and the vibrating unit 122 and voice information to be output through the earphone 4 to the main body 1.

The control data includes LED driving pattern, LED lighting speed, position information on first lighting LED, LED brightness information, etc. Moreover, control signals supplied from the control unit 63 to the motor driver 64 are provided to the control box 2 through the wire port 61. The control box 2 drives the vibrating pad 5 or provides voice information such as beep sound or narration information to the main body 1 in synchronization with a motor driving signal from the main body 1. The voice information provided by the control box 2 is delivered to the earphone 4 through the earphone connecting port 62.

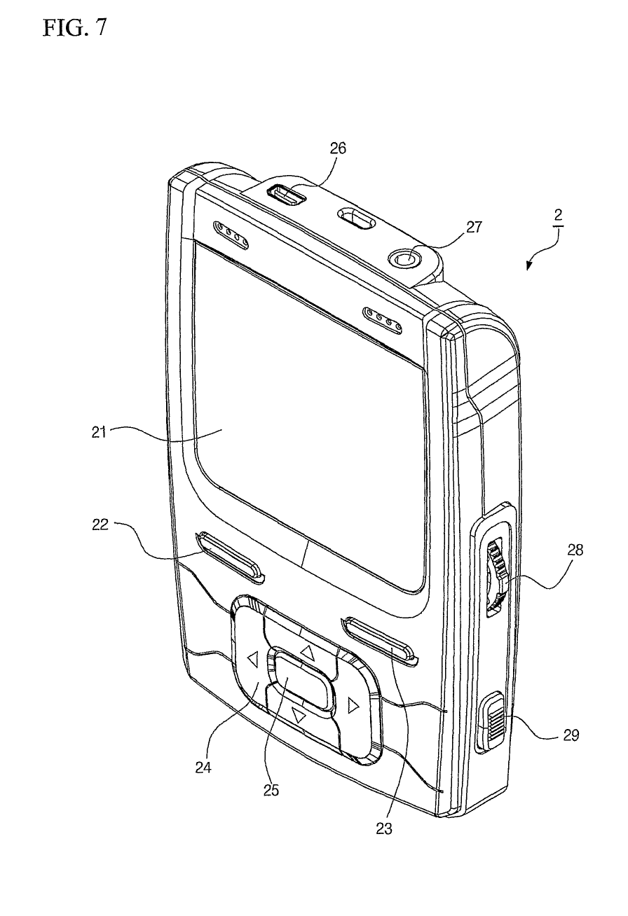

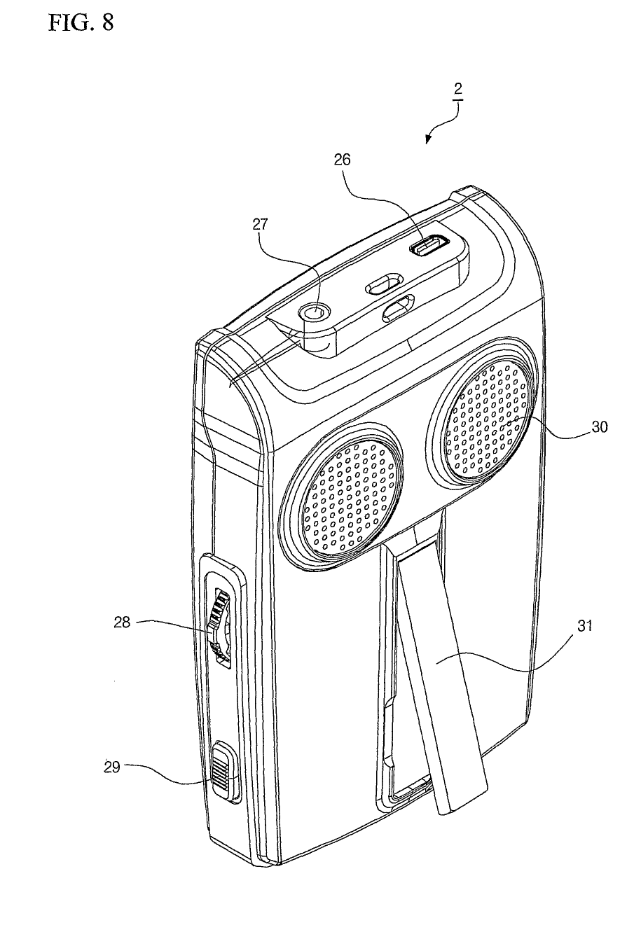

FIG. 7 is a front perspective view of the control box 2 of FIG. 1, and FIG. 8 is a rear perspective view of the control box 2 of FIG. 1.

A display panel 21 for display an operation state of the device or selecting an operation mode is provided on the front surface of the control box 2. Moreover, a menu key 22, a search key 23, a direction key 24, and a selection key 25 are provided at the bottom of the display panel 21. Here, the search key 23 is used to allow the user to search for a treatment scenario and the like.

A wire jack 26 for detachably connecting the wire 3 and a vibrating pad connecting jack 27 for connecting the vibrating pad 5 are provided at the top of the control box 2. A volume control key 28 for controlling the volume of sound output from the earphone 4 or a speaker 30 to be described later and a hold key 29 for temporarily stopping the operation of the main body 1 are provided on one side of the control box 2. Although not shown in the figures, a recording key and a power key are provided on the other side of the control box 2. Moreover, a power jack for inputting an external power and a USB port, for example, for connecting the control box 2 to a personal computer, for example, are provided at the bottom of the control box 2.

The speaker 30 for outputting voice sound and a support 31 for supporting the control box 2 in a standing position are provided on the rear surface of the control box 2.

The user can select the operation mode and the operation state of the psychotherapeutic device of the present invention using the menu key 22, the direction key 24, and the selection key 25. The operation modes that the user can select include LED focus adjustment, beep sound output during operation of LEDs, operation of the vibrating unit 122 or the vibrating pad 5, narration reproduction, background music reproduction, voice recording, swing speed variation of the LED display, LED brightness adjustment, vibration intensity adjustment of the vibrating unit 122 or the vibrating pad 5, treatment program download, and the like. The user selects a desired operation mode using the menu key 22 and selects an operation state using the direction key 24 and the selection key 25.

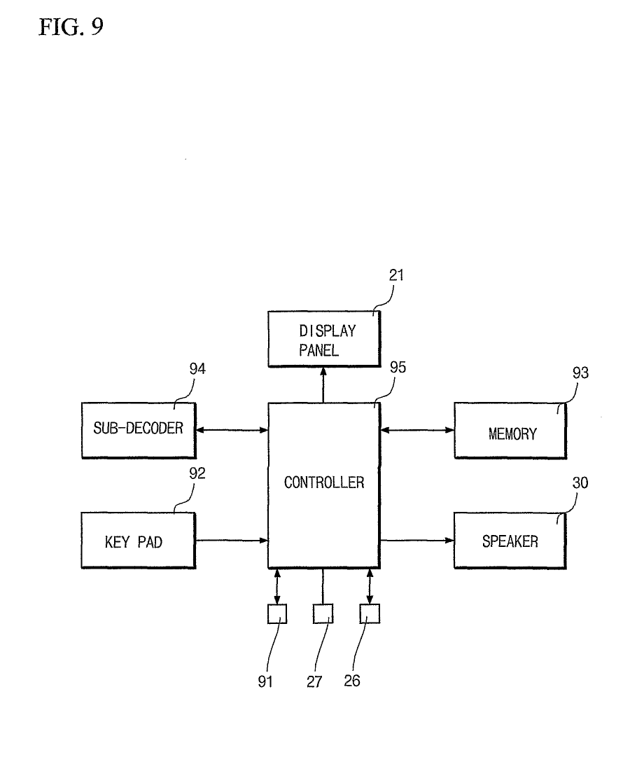

FIG. 9 is a block diagram schematically showing an internal circuit of the control box 2.

The control box 2 including the display panel 21, the USB port 91, the wire jack 26, the vibrating pad connecting jack 27, and the speaker 30 further includes a key pad 92 for detecting the operation of an external key, a memory 93 for storing the background music and the narration information, a sub-decoder 94 for decoding background music data, and a controller 95 for controlling the entire device. Especially, the controller 95 performs narration reproduction, analog/digital and digital analog conversion of various input and output data, background music and narration information synthesizing operation, etc. besides the entire control operation.

The control box 2 further includes a power unit including a rechargeable battery for operating the device.

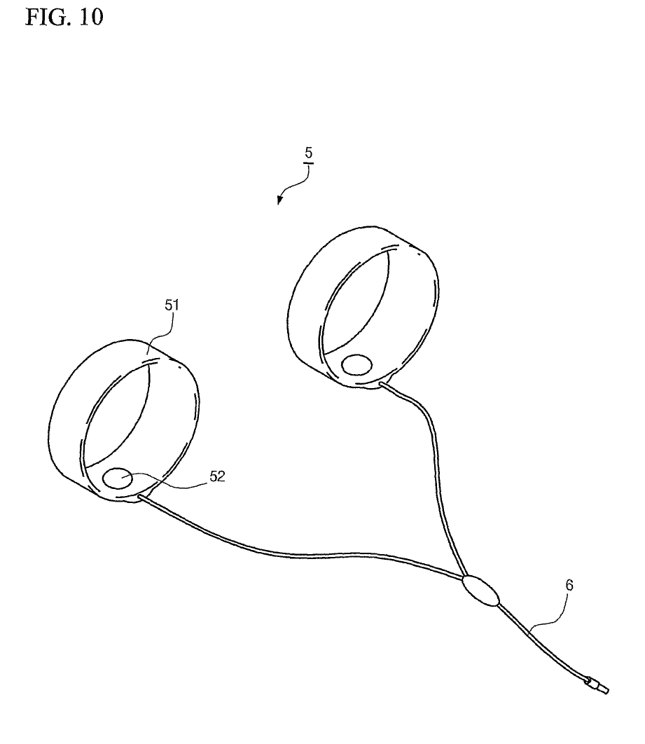

FIG. 10 is a perspective view of the vibrating pad 5. The vibrating pad 5 includes a pair of circular pads 51 and a vibrating plate 52 mounted on each of the circular pads 51. The pair of circular pads 51 are formed of an elastic material such as silicon resin, for example, and the vibrating plate 52 is electrically connected to the control box 2 by the wire 6. The vibrating pad 5 may be worn on the user's wrist, if necessary.

The shape of the vibrating pad 5 is not limited to a specific one and may have an oval sphere shape, for example, such that the user can easily hold the vibrating pad 5.

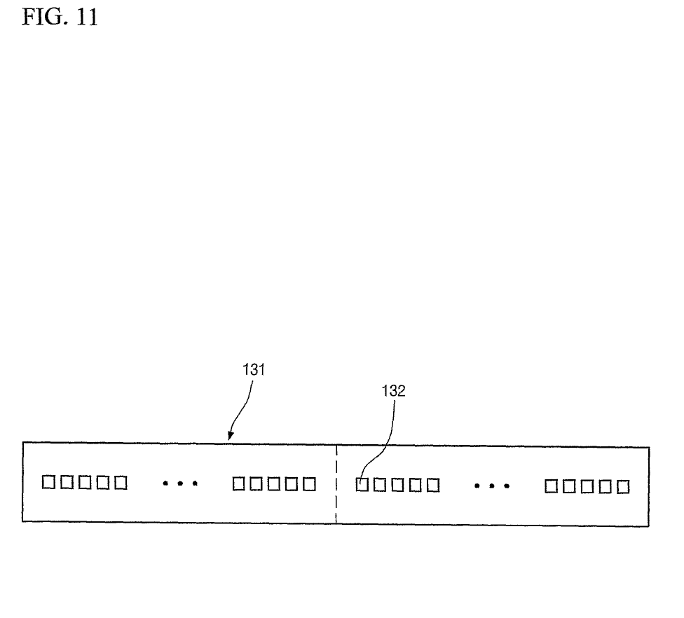

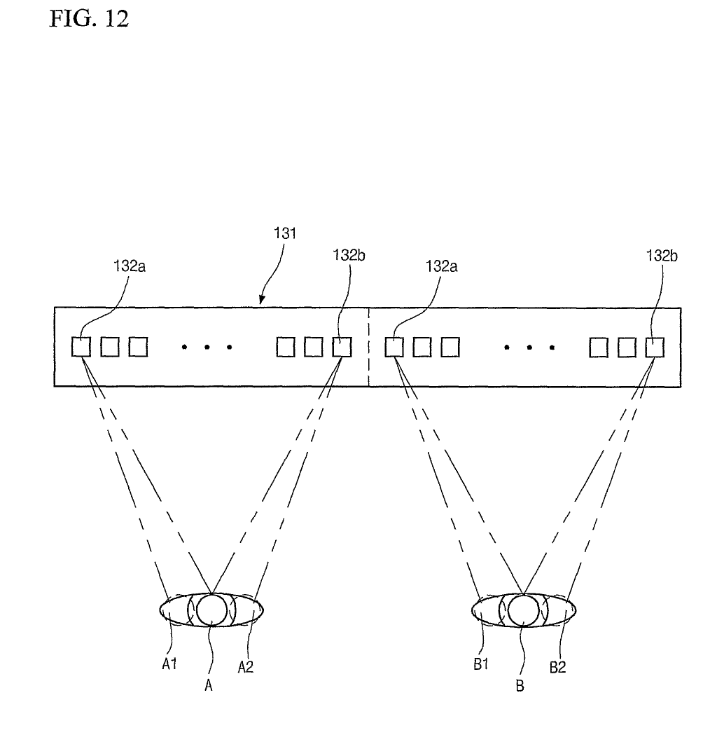

FIGS. 11 and 12 are diagrams illustrating the operation of the main body 1 and schematically showing the states in which a plurality of LEDs 132 are arranged with respect to left and right eyes A and B while the main body 1 is placed on the user's face.

When the main body 1 is placed on the user's face, the LEDs 132 are arranged on the left and right sides within a predetermine angle range with respect to the left and right eyes A and B. When the user selects an operation mode of the control box 2, the controller 95 provides a variety of operating data such as position information on first lighting LED 132, LED brightness information, vibration intensity information of the vibrating unit 122, and LED lighting pattern information to the control unit 63 of the main body 1.

The control unit 63 of the main body 1 controls the operations of the LEDs 132 and the motor driver 64 based on the operating data applied from the controller 95. That is, the control unit 63 sequentially turns on and off the plurality of LEDs 132 from the LED 132a located at the left end to the LED 132b located at the right end and, then, sequentially turns on and off the plurality of LEDs 132 from the LED 132b located at the right end to the LED 132a located at the left end, and this operation is repeated. Then, the user's eyes A and B are reciprocated between A1 and A2 and between B1 and B2, respectively. Moreover, the control unit 63 operates the vibrating unit 122 through the motor driver 64 in synchronization with the operation of the LEDs 132 such that a physical stimulus is applied to the left and right sides of the user's body.

During the above operation, the controller 95 may output a voice signal for the psychiatric treatment of the user, for example, a voice message such as “Please recall a memory that you want to forget” through the speaker 30 or the earphone 4. Moreover, the controller 95 outputs a beep sound through the earphone 4 and operates the vibrating pad 5 to apply a physical stimulus to the left and right sides of the user's body in synchronization with the motor driving signal input from the main body 1 through the wire jack 26, that is, when the control unit 63 of the main body 1 turns on the LEDs 132 and 132b located at both ends. Of course, in this case, the output of the beep sound and the operation of the vibrating unit 122 or the vibrating pad 5 may be selected by the user through the menu key 22 and the selection key 25 of the control box 2.

The operation of the vibrating unit 122 or the vibrating pad 5 is performed in synchronization with the operation of the LEDs 132. That is, the control unit 63 and the controller 95 operate the vibrating unit 122 and the vibrating pad 5 corresponding to the left side of the user's body when the LED 132a located at the left end is turned on, and operate the vibrating unit 122 and the vibrating pad 5 corresponding to the right side of the user's body when the LED 132b located at the right end is turned on.

Moreover, the control box 2 may provide a flickering sound such as a beep sound in accordance with the lighting operation of the LEDs 132 through the earphone 4. The flickering sound is provided to the user through the left earphone 4 at the very time when the left LED 132a is turned on and provided to the user through the right earphone 4 at the very time when the right LED 132b is turned on.

It is preferable that a meditation music or a voice message be provided through the earphone 4 in addition to the flickering sound.

Meanwhile, since the user gazes at the LEDs 132 in the left row with the left eye and gases at the LEDs 132 in the right row with the right eye, the light spots emitted by the LEDs 132 and seen through the user's eyes may not be focused into one. In the case where the focus positions of the LEDs 132 seen through the user's eyes do not coincide with each other, two LEDs are seen through the user's eyes and, when the user performs the eye movement in this state, the user may experience dizziness.

A focus adjustment function is provided to solve the above problem.

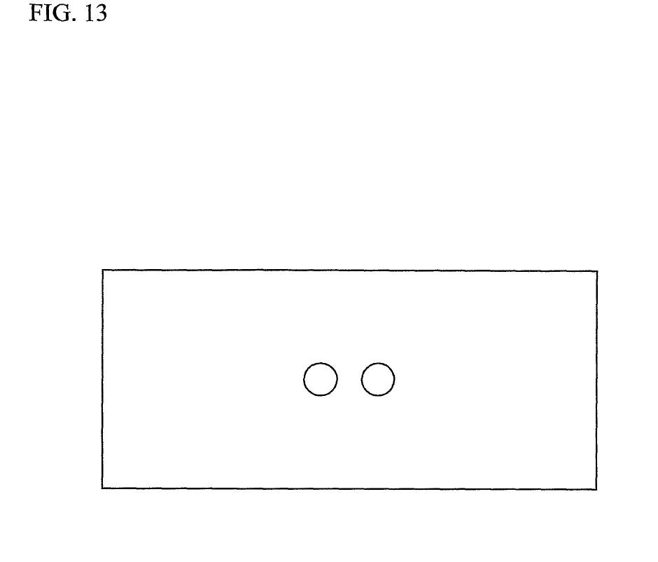

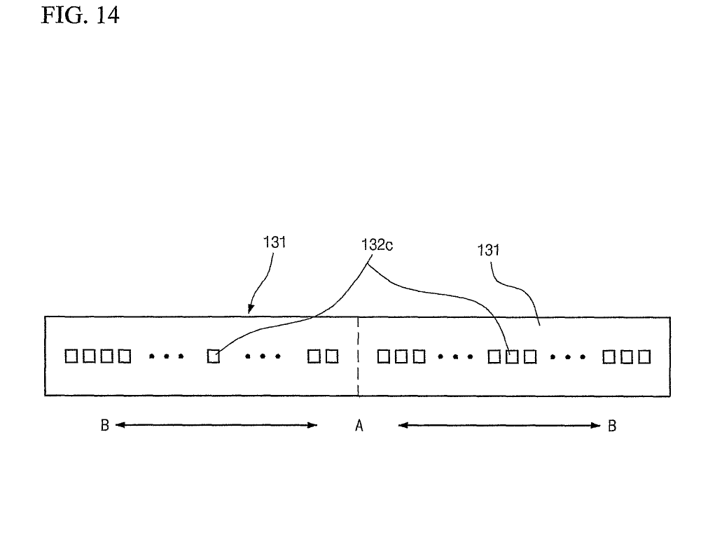

In the case where the light spots emitted by the LEDs 132 are seen as two images as shown in FIG. 13 while the main body 1 is placed on the user's face, the user operates the control box 2 to select a focus adjustment mode. The focus adjustment mode is selected using the menu key 22 and the selection key 25. When the focus adjustment mode is selected, the user can perform a focus adjustment operation using the direction key 24. That is, when the focus adjustment mode is selected, the controller 95 and the control unit 63 turn on only the LEDs 132c located at the middle of each of the left and right rows on the LED substrate 131 and then enter the focus adjustment mode.

When the user presses the direction key 24 of the control box 2 in the focus adjustment mode, the controller 95 and the control unit 63 move the turned-on LEDs 132 to the A-side or the B-side based on the LEDs 132c every time when the user presses the left or right direction key 24. When the turned-on left and right LEDs 132 mounted on the LED substrate 131 are moved in the A direction, the distance between the turned-on left and right LED 132 gradually decreases, and thus the distance between the two images of FIG. 13 seen through the user's eyes also decreases. On the contrary, when the turned-on left and right LEDs 132 are moved in the B direction, the distance between the turned-on left and right LED 132 gradually increases, and thus the distance between the two images of FIG. 13 seen through the user's eyes also increases. Therefore, the user can adjust the images seen through the use's eyes to be combined by operating the direction key 24 while the main body 1 is placed on the user's face.

When the focus adjustment mode is terminated, the controller 95 stores the position information on the corresponding LEDs and provides the stored LED position information as initial position information of the LEDs during the next operation of the main body 1.

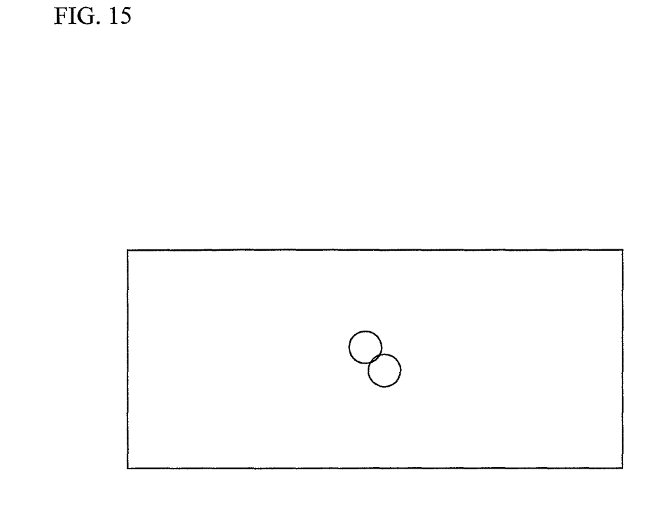

Meanwhile, even in the case where the light spots emitted by the LEDs 132 are focused into one in the above manner, two light spots of the LEDs 132 may be seen through the user's eyes as shown in FIG. 15 according to the horizontal state between the main body 1 and the eyes when the main body 1 is placed on the user's face. In this state, the user can focus the light spots seen through the eyes into one by rotating the front panel 13 connected to the connecting member 112 with respect to the pivot 112b.

Moreover, after focusing the light spots into one in the above manner, it is possible to appropriately adjust the size of the light spot seen through the eyes by moving up and down the connecting member 112 with respect to the frame 11.

Although the focus adjustment operation has been described with respect to the case where the light spots are provided by the LEDs 132, this operation can be applied to the case where a display such as an LCD is used as the front panel 13 in the same manner. However, in the case where the display is used, the control unit 63 may move the positions of light emitting pixels on the display left and right every time when the user presses the direction key 24. Moreover, in the case where the display is used, the user may move the pixel positions on the display up and down using the direction key 24, instead of rotating the front panel 13 with respect to the connecting member 112.

According to the present invention having the above configuration, the user can perform the eye movement accurately and conveniently only by gazing at the light displayed on the front panel while the main body 1 according to the present invention is placed on the user's face.

Moreover, since the vibration generating means is driven in synchronization with the operation of the front panel, the user can receive the psychiatric treatment according to the brain stimulation method without the aid of a doctor.

The present invention is not limited to the above described embodiment, but can be modified in various manners within the scope of the invention.

For example, although the description has been given with respect to the case where the main body 1 is connected to a separate control box 2, an ordinary personal computer or a cellular phone may be used as the control box 2.

Moreover, the structure in which the front panel 13 is moved or rotated with respect to the frame 11 is not limited to a specific one, but any other structure may be used.

1. A psychotherapeutic device comprising:
a main body including a frame having an opened portion corresponding to a user's eyes, a support means for placing the frame on the user's face, and a front panel connected to a front surface of the frame and providing light spots moved left and right with respect to the user's eyes; and
a control box for controlling the operation of the front panel,
wherein the main body and the control box are electrically connected to each other by a wire.

2. The psychotherapeutic device of claim 1, wherein the front panel is connected to the frame to be moved up and down.

3. The psychotherapeutic device of claim 1, wherein the front panel is rotatably connected to a middle portion of the frame.

4. The psychotherapeutic device of claim 1, wherein the main body further includes a vibrating means provided at positions corresponding to both sides of the user's face.

5. The psychotherapeutic device of claim 1, wherein the main body further includes an earphone for outputting a voice signal therethrough.

6. The psychotherapeutic device of claim 1, wherein the front panel includes a plurality of LEDs provided in the inside thereof in the longitudinal direction to provide the light spots, in which the plurality of LEDs are divided into a first row corresponding to the left eye of the user and a second row corresponding to the right eye of the user, the plurality of LEDs in the first row and the second row are turned on and off one by one, and the turned-on position is sequentially moved in the left or right direction.

7. The psychotherapeutic device of claim 6, wherein the control box further includes a position adjustment means for adjusting the positions of the LEDs which are simultaneously turned on and off among the LEDs in the first and second rows.

8. The psychotherapeutic device of claim 5, wherein the control box outputs a meditation music through the earphone.

9. The psychotherapeutic device of claim 1, wherein the control box further includes a light amount adjustment means for adjusting the amount of light emitted from the LEDs.

10. The psychotherapeutic device of claim 1, wherein the front panel is a display.

11. The psychotherapeutic device of claim 1, further comprising a vibration generating means for applying a physical stimulus to the left and right sides of the user's body,
wherein the control box operates the vibration generating means in synchronization with the operation of the front panel.

12. The psychotherapeutic device of claim 1, wherein the front panel includes a shielding pate provided on the front surface thereof, the shielding plate being connected to the frame to be moved up and down.
